(19) United States
(12) Patent Application Publication
(10) Pub. No.: US 2020/0356906 A1
(43) Pub. Date: Nov. 12, 2020

(54) MANAGEMENT SYSTEM AND MANAGEMENT METHOD FOR ALLOCATING VEHICLE

(71) Applicant: DENSO CORPORATION, Kariya-city (JP)

(72) Inventor: Satoshi Yoshinaga, Kariya-city (JP)

(21) Appl. No.: 16/869,532

(22) Filed: May 7, 2020

(30) Foreign Application Priority Data
May 8, 2019 (JP) 2019-88520

(51) Int. Cl. G06Q 10/02; H04W 4/021; H04W 4/40; G08G 1/14; G06Q 50/30

(52) U.S. Cl. CPC G06Q 10/02; H04W 4/021; G06Q 50/30; G08G 1/146; H04W 4/40

(57) ABSTRACT

In a management system for managing vehicle parking, a communication unit is configured to receive, from a user, a vehicle allocation request including a number of occupants, a desired boarding location, and a desired boarding time. A vehicle selection unit is configured to secure one or more vehicles corresponding to the number of occupants based on the vehicle allocation request. A reservation control unit is configured to, in response to a parking space for the secured vehicle being allocated to a parking candidate site corresponding to the desired boarding location during a parking time period corresponding to the desired boarding time, allocate a reservation for the parking space during the parking time period to the parking candidate site and allocating the vehicle to the user.

### CROSS-REFERENCE TO RELATED APPLICATION

This application is based on and claims the benefit of priority from earlier Japanese Patent Application No. 2019-88520 filed on May 8, 2019, the description of which is incorporated herein by reference.

### BACKGROUND

### Technical Field

The present disclosure relates to a management system and a management method for allocating a vehicle.

### Related Art

Conventionally, there is a technique for allocating a vehicle.

For example, a known vehicle allocation system uses a parking lot of an apartment as an allocation destination of a rental vehicle. In this vehicle allocation system, a vehicle allocation server receives a rental reservation via a network, and reserves a parking section of the apartment having the parking lot to which a rental vehicle is allocated, thereby avoiding a situation where vehicle allocation is impossible.

For example, a known technique discloses a center device which acquires information indicating a current location of a user and information indicating a current location and a use situation of a vehicle, and based on these pieces of information, the center device determines a vehicle to be allocated that can be allocated to the user and a boarding location. The center device sets a user route from the current location of the user to the boarding location and a vehicle route from the current location of the vehicle to be allocated to the boarding location.

### BRIEF DESCRIPTION OF THE DRAWINGS

In the accompanying drawings:

FIG. 1 is a block diagram showing a configuration of a management system according to first and second embodiments of the present disclosure;

FIG. 2 is a schematic block diagram showing an example of a computer that functions as a center;

FIG. 3 is a diagram for explaining a basic concept of management of vehicle allocation according to the embodiments of the present disclosure;

FIG. 4 is a diagram showing a relationship between a parking candidate site and a parking space;

FIG. 5 is a flow chart showing a processing routine at the time of reservation performed by the management system according to the first embodiment of the present disclosure;

FIG. 6 is a diagram showing an example in which parking spaces for vehicles having similar vehicle specifications are overlapped with each other;

FIG. 7 is a diagram showing a case where vehicle allocations for users are exchanged between the vehicles having similar vehicle specifications;

FIG. 8 is a diagram showing an example in which parking spaces for vehicles that mutually accept the number of occupants are overlapped with each other;

FIG. 9 is a diagram showing a case where vehicle allocations for users are exchanged between the vehicles that mutually accept the number of occupants;

FIG. 10 is a diagram showing an example in which parking spaces for vehicles are overlapped with each other based on departure time;

FIG. 11 is a flow chart showing a processing routine at the time of reservation performed by the management system according to the second embodiment of the present disclosure; and

FIG. 12 is a flow chart showing a processing routine at the time when a user boards a vehicle performed by the management system according to the second embodiment of the present disclosure.

### DESCRIPTION OF SPECIFIC EMBODIMENT

The known technique, as disclosed in JP-A-2014-211778, does not manage approximately how long a parking space in a parking candidate site is used, and in some cases, an issue occurs in which the parking space in the parking candidate site is unavailable during a time in which the parking space is to be used.

The known vehicle allocation system only determines availability of the parking section at the time of determination. Thus, such a vehicle allocation system has an issue in which when a vehicle that is not under management by the vehicle allocation system uses the parking lot in the parking section reserved by the vehicle allocation system, vehicle allocation in the reserved location is impossible. Similarly, the known technique, as disclosed in JP-A-2016-91411, has an issue in which when a location determined as the boarding location is blocked by another vehicle or the like, vehicle allocation is impossible.

Thus, the vehicle allocation also requires a technique for efficiently managing a parking space.

In view of the foregoing, it is desired to have a management system and a management method for appropriately managing vehicle allocation.

Hereinafter, exemplary embodiments of the present disclosure will be described in detail with reference to the accompanying drawings, in which like reference numerals refer to like or similar elements regardless of reference numerals and duplicated description thereof will be omitted.

A technique according to the embodiments of the present disclosure relates to a management system for managing vehicle allocation. The management system manages a parking space together with a time period in which the parking space is used. The parking space is a space used as a boarding/alighting location and a vehicle waiting place when a vehicle is allocated. The management system performs the management to prevent another vehicle from occupying the parking space during the time period in which the parking space is used.

Thus, the management performed by the management system can prevent a situation where when vehicle allocation requests for a specific location are concentrated in a specific time period, a user cannot use an allocated vehicle due to lack of available boarding/alighting space. For example, the management performed by the management system can address a situation where a shared vehicle is allocated to a rotary at a station during rush hour in which congestion is expected.

Efficient assignment of the parking space allows many vehicles to be parked in a parking candidate site, leading to efficient use of the parking site. Furthermore, the management of the parking space according to a time period makes it possible to avoid a situation where a traffic jam is caused by a vehicle waiting on a roadway until the parking space becomes available.

### First Embodiment

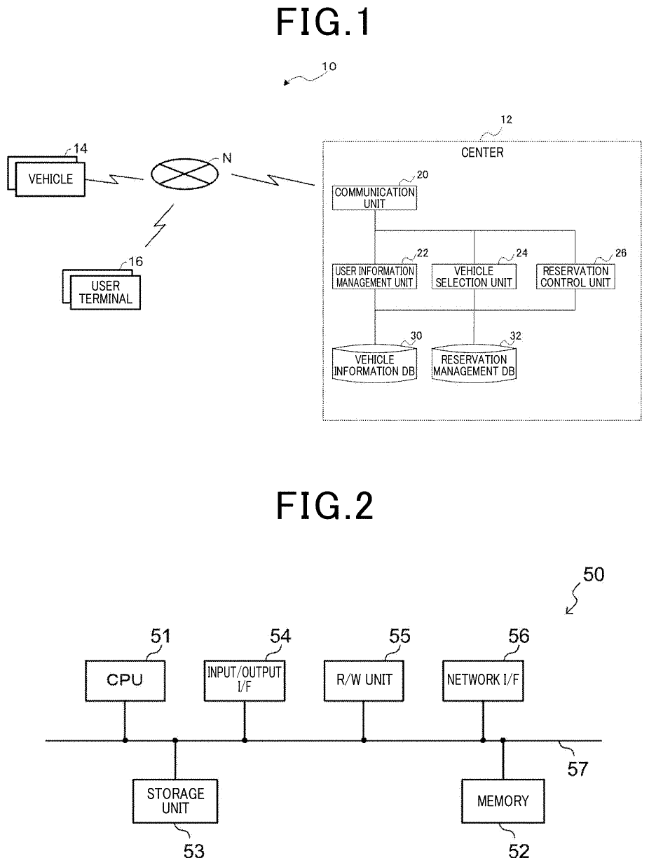

A configuration of the management system according to a first embodiment of the present disclosure will be described with reference to FIG. 1. FIG. 1 is a block diagram showing a configuration of a management system 10 according to the first embodiment of the present disclosure. As shown in FIG. 1, the management system 10 includes a center 12, a plurality of vehicles 14 to be managed, and a plurality of user terminals 16. An example in which the management system 10 includes a single center 12 will be described, but a plurality of centers 12 may be provided in a cloud environment or the like to perform distributed processing.

FIG. 2 is a schematic block diagram showing an example of a computer that functions as the center 12. For example, the center 12 can be implement by a computer 50 shown in FIG. 2. The computer 50 includes a CPU (Central Processing Unit: processor) 51, a memory 52 as a temporary storage area, and a non-volatile storage unit 53. Furthermore, the computer 50 includes an input/output interface (I/F) 54 to which an input/output device and the like (not shown) are connected, and a read/write (R/W) unit 55 that controls reading of data from and writing of data in a recording medium. Furthermore, the computer 50 includes a network I/F 56 that is connected to a network N such as the Internet. The CPU 51, the memory 52, the storage unit 53, the input/output I/F 54, the R/W unit 55, and the network I/F 56 are connected to each other via a bus 57.

The storage unit 53 can be implemented by a Hard Disk Drive (HDD), a solid-state drive (SSD), a flash memory, or the like. The storage unit 53 as a storage medium stores a program for allowing the computer 50 to function. The CPU 51 reads the program from the storage unit 53 and expands the read program in the memory 52, and sequentially performs a process of the program.

The example of the electrical configuration of the computer in FIG. 2 has been described above.

A configuration of the management system 10 will be described below.

The center 12 is a server that manages vehicle allocation according to a request from the user terminal 16. The center 12 includes a communication unit 20 and a reservation control unit 26.

The vehicle 14 is a vehicle allocated based on a vehicle allocation request from a user who possesses the user terminal 16. A vehicle size such as the allowed number of occupants has been determined for the vehicle 14. The vehicle 14 is assumed to be a self-driving vehicle (self-driving taxi or self-driving bus), a shared vehicle, or the like. The vehicle 14 communicates with the center 12 as appropriate to refer to a vehicle allocation arrangement situation in a vehicle information DB 30, and travels to a vehicle allocation destination. The vehicle allocation arrangement situation may be transmitted from the center 12 to the vehicle 14.

The user terminal 16 is, for example, a mobile terminal such as a smartphone or a tablet, and can be used to input and transmit a vehicle allocation request via a website browser, a program installed in the mobile terminal in advance, or the like. When a user who possesses the user terminal 16 wishes vehicle allocation, the user inputs a vehicle allocation request to the user terminal 16. The user inputs, to the user terminal 16, a vehicle allocation request including the number of occupants, a desired boarding location, and a desired boarding time, and the user terminal 16 transmits the vehicle allocation request to the center 12. Furthermore, when the user arrives at a parking candidate site, the user terminal 16 transmits arrival information including authentication information. Hereinafter, the user terminal 16 indicates a single specific user terminal 16.

The components and DBs of the center 12 will be described below.

The vehicle information DB 30 stores information on the vehicles managed by the center 12. The information on the vehicles is information such as the allowed number of occupants, a vehicle type, a size, a current location, and a vehicle allocation arrangement situation of the vehicles. The current location is notified by the vehicles as appropriate. The vehicle allocation arrangement situation is information including a time in which the vehicle is occupied by reservation and a parking candidate site to which the vehicle is allocated.

A reservation management DB 32 stores reservation information on the vehicle allocation managed by the center 12 and user information on the users who possess the user terminal 16. The reservation information on the vehicle allocation includes a reservation situation of a vehicle allocation location for each time period in each parking candidate site, and is updated by the reservation control unit 26. The user information is various IDs, registration information, vehicle allocation use information of the user terminal 16, and is updated as appropriate.

The communication unit 20 receives a vehicle allocation request from the user terminal 16. Furthermore, the communication unit 20 transmits vehicle allocation information to the vehicle 14 and the user terminal 16.

A user information management unit 22 generates vehicle allocation information based on the reservation information, and transmits the vehicle allocation information from the communication unit 20 to the vehicle 14 and the user terminal 16. The vehicle allocation information includes, for example, a notification “Reservation for vehicle No. XXXX at XX:XX at XX location (map) is completed”. Furthermore, the vehicle allocation information includes authentication information such as a QR code or an authentication ID that is required when the user boards the vehicle. Furthermore, when the vehicle assigned to the user is changed, the user information management unit 22 transmits, to the user terminal 16 of the user, a notification notifying the user to board the vehicle allocated after the change.

Based on the vehicle allocation request, a vehicle selection unit 24 secures one or more vehicles corresponding to the number of occupants from the vehicles whose information is stored in the vehicle information DB 30.

The reservation control unit 26 determines whether a parking space for the vehicle secured by the vehicle selection unit 24 can be allocated, during a parking time period corresponding to the desired boarding time, to the parking candidate site whose information is stored in the reservation management DB 32 and that corresponds to the desired boarding location, i.e., the reservation control unit 26 determines whether vehicle allocation is possible. A condition for the determination will be described later in description of an operation of the management system 10. If the vehicle allocation is possible, for the vehicle secured by the vehicle selection unit 24, the reservation control unit 26 allocates a reservation for the parking space during the parking time period to the parking candidate site. Based on the content of the reservation, the reservation control unit 26 updates the reservation information on the parking candidate site in the reservation management DB 32. Furthermore, the reservation control unit 26 updates the vehicle allocation arrangement situation on the secured vehicle in the vehicle information DB 30.

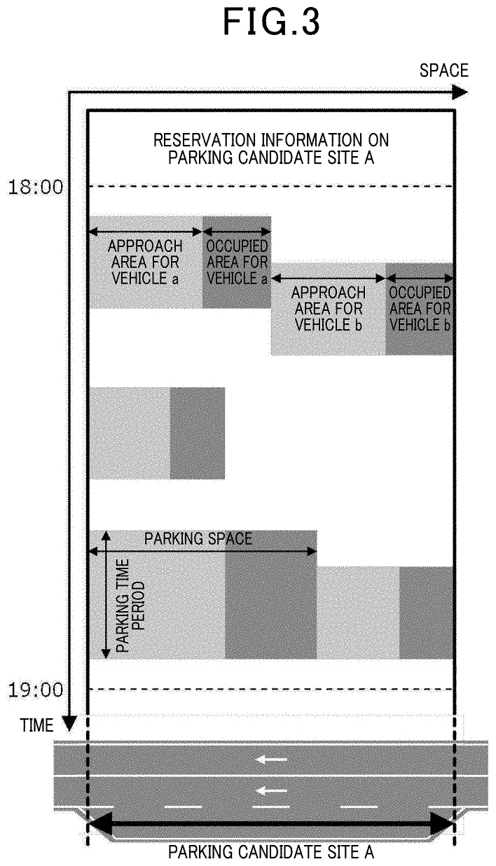

A method of managing vehicle allocation will be described below. FIG. 3 is a diagram for explaining a basic concept of the management of vehicle allocation according to the embodiments of the present disclosure. FIG. 3 shows reservation information on vehicle allocation during a time period from 18:00 to 19:00 in parking candidate site A. FIG. 3 shows that in parking candidate site A, reservations have been made for vehicle a and vehicle b during overlapping time periods after 18:00. A vertical axis represents a parking time period secured by reservation, and a horizontal axis represents a parking space secured by reservation. The parking time period is time required for an allocated vehicle to be parked and departed, and as the parking time period, a time before, during, and after the desired boarding time is secured. The amount of time to be secured before and after the desired boarding time may be arbitrarily determined according to the rules of the management system 10. The parking space is secured as a space including an occupied area and an approach area for each vehicle. The occupied area is a space occupied by a vehicle when parking of the vehicle is completed. The approach area is a space required to be secured for parking or departure of the vehicle. FIG. 3 shows an example in which the parking space includes a single approach area. However, the parking space may include two approach areas provided in front of and behind the occupied area. An appropriate size of the occupied area and the approach area is determined according to a vehicle type of the vehicle. The determination of the appropriate size of the occupied area and the approach area allows more accurate management.

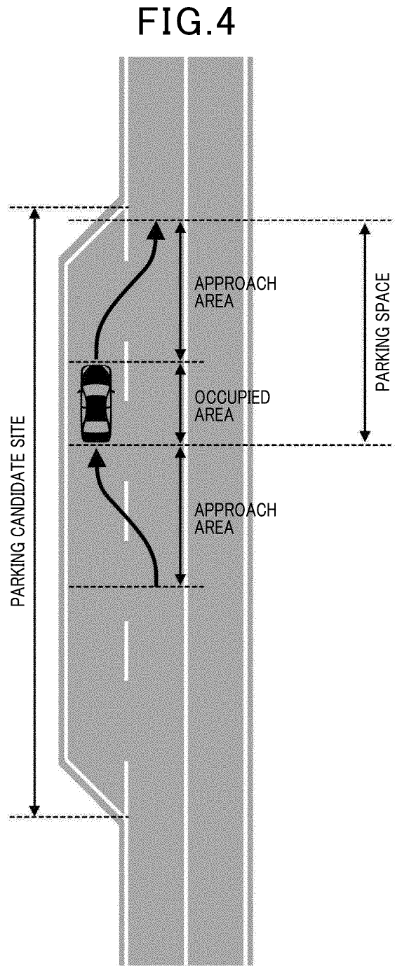

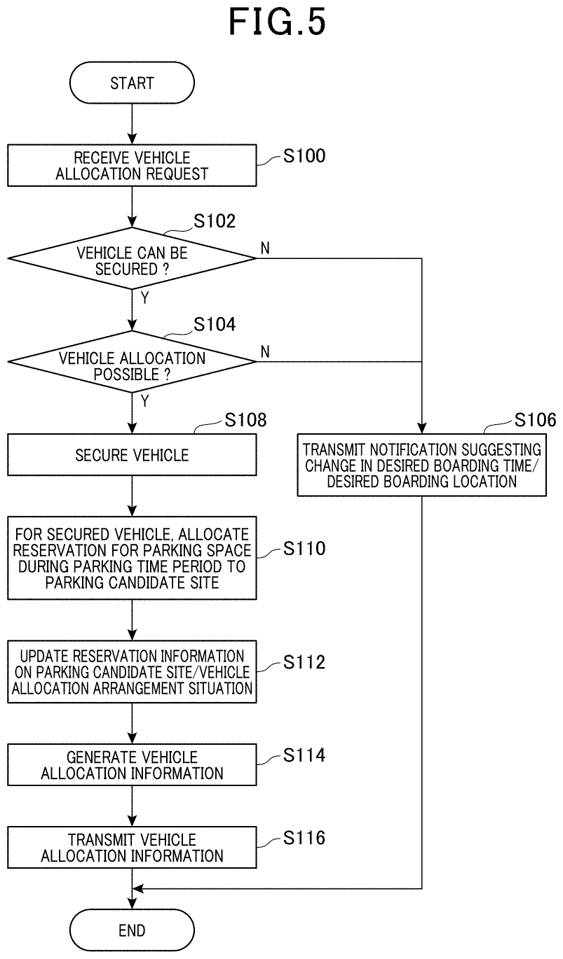

A concept of the approach area will be described below. FIG. 4 shows a relationship between a parking candidate site and a parking space. As shown in FIG. 4, in the parking candidate site, a vehicle is allocated as close to the front side as possible and assumed to be departed from the front side. Thus, as the parking space, an approach area on the front side required for the departure and an occupied area are secured. When the parking candidate site has sufficient space, as the parking space, an approach area required for parking may also be secured.

Under the above assumption, when the condition that a size of the parking candidate site a total size of the necessary parking space per unit time of the parking time period is satisfied, the reservation control unit 26 of the center 12 determines that a reservation is possible. The unit time is a unit time of the parking time period, and is determined to be 1 minute or the like.

Next, an operation of the management system 10 according to the first embodiment of the present disclosure will be described. FIG. 5 is a flow chart showing a processing routine at the time of reservation performed by the management system 10 according to the first embodiment of the present disclosure.

At step S100, the communication unit 20 receives a vehicle allocation request from the user terminal 16. The vehicle allocation request includes the number of occupants, a desired boarding location, and a desired boarding time.

At step S102, based on the vehicle allocation request, the vehicle selection unit 24 determines whether one or more vehicles corresponding to the number of occupants can be secured from the vehicles whose information is stored in the vehicle information DB 30. If one or more vehicles can be secured, control proceeds to step S104, and if not, control proceeds to step S106. The vehicles determined to be secured are vehicles that are not occupied at the desired boarding time and can reach the desired boarding location at the desired boarding time.

At step S104, the reservation control unit 26 determines whether a parking space for the vehicle secured by the vehicle selection unit 24 can be allocated, during a parking time period corresponding to the desired boarding time, to the parking candidate site whose information is stored in the reservation management DB 32 and that corresponds to the desired boarding location, i.e., the reservation control unit 26 determines whether vehicle allocation is possible. If the vehicle allocation is possible, control proceeds to step S108, and if not, control proceeds to step S106. The reservation control unit 26 determines whether the vehicle allocation is possible by examining the reservation information in the reservation management DB 32. If the condition that the size of the parking candidate site the total size of the necessary parking space per unit time of the parking time period is satisfied, the reservation control unit 26 determines that the vehicle allocation is possible, and if not, the reservation control unit 26 determines that the vehicle allocation is impossible. Assume that reservations for which a plurality of vehicles have been allocated to the parking candidate site have already been made, and the vehicle secured at step S102 is further allocated to the parking candidate site. In the calculation to make the most of the space, the total size of the necessary parking space is a size of an occupied area for each vehicle to be reserved and a single approach area, which is an approach area required for departure of the vehicles. This is because the single approach area allows the vehicles to be sequentially departed, starting from the foremost vehicle. Thus, when at least an occupied area for each vehicle to be reserved and a single approach area can be allocated, the reservation control unit 26 determines that the vehicle allocation is possible.

At step S106, based on the determination that the vehicle allocation is impossible, the user information management unit 22 transmits, from the communication unit 20 to the user terminal 16 possessed by the user, a notification suggesting a change in the desired boarding time or the desired boarding location.

At step S108, the vehicle selection unit 24 secures the vehicle to be allocated from the vehicles whose information is stored in the vehicle information DB 30.

At step S110, the reservation control unit 26 allocates, for the secured vehicle, a reservation for the parking space during the parking time period to the parking candidate site whose information is stored in the reservation management DB 32 and that corresponds to the desired boarding location.

At step S112, based on the content of the reservation, the reservation control unit 26 updates the reservation information on the parking candidate site in the reservation management DB 32 and the vehicle allocation arrangement situation for the secured vehicle in the vehicle information DB 30.

At step S114, based on the reservation information, the user information management unit 22 generates vehicle allocation information for the user terminal 16.

At step S116, the communication unit 20 transmits the vehicle allocation information to the user terminal 16, and the process ends.

As described above, the management system 10 according to the first embodiment of the present disclosure can appropriately manage vehicle allocation. Furthermore, the unified management of vehicle allocation performed by the center 12 can mitigate the risk that the parking space in which the vehicle is allocated is unavailable.

### Second Embodiment

In a second embodiment, an example will be described in which the parking spaces are overlapped with each other for optimization. A configuration of the second embodiment is the same as that of the first embodiment shown in FIG. 1 and thus will be described with the same reference numerals.

In a case where the parking spaces for the vehicles can be overlapped with each other according to the conditions, the reservation control unit 26 optimizes the placement of the vehicles in the parking candidate site so that the parking spaces for the vehicles are overlapped with each other. When a plurality of vehicle allocation requests have been made for overlapping parking time periods and a new reservation cannot be allocated unless the parking spaces for the vehicles are overlapped with each other, the reservation control unit 26 determines whether the parking spaces can be overlapped with each other, and if the overlap of the parking spaces is possible, the reservation control unit 26 performs the optimization. The reservation control unit 26 determines that the overlap of the parking spaces is possible when one of the following cases (described later) applies and when an occupied area for a newly allocated vehicle is allocated to the parking candidate site. When the reservation control unit 26 determines that the overlap of the parking spaces is possible, the reservation control unit 26 optimizes the placement of the vehicles in the parking candidate site so that an occupied area of a parking space allocated to a vehicle parked on the front side is overlapped with an approach area for a vehicle that follows the vehicle parked on the front side and is parked on the rear side. Thus, a total parking space is occupied areas for each vehicle to be reserved and one or more approach areas required for departure of the vehicles.

As examples where the parking spaces can be overlapped with each other, three cases will be described. Conditions described in the three cases are examples of the predetermined condition.

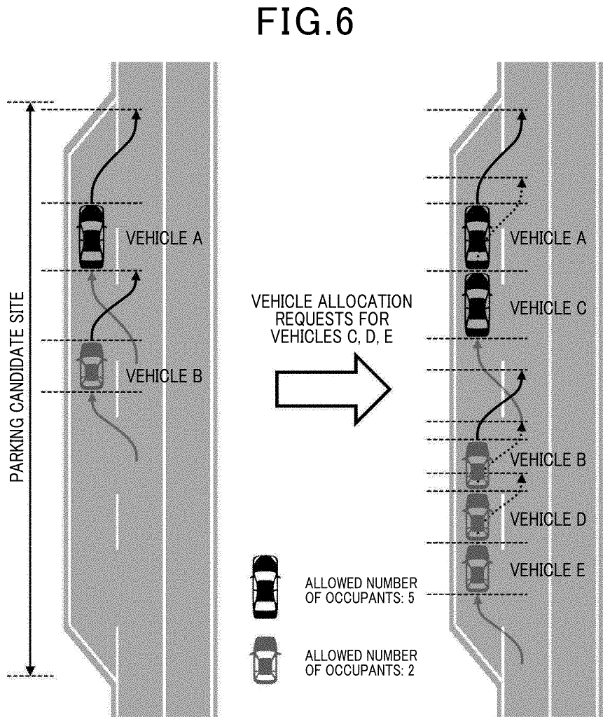

First, as the first case, a case where the vehicles have similar vehicle specifications will be described. FIG. 6 shows an example in which the parking spaces for the vehicles having similar vehicle specifications are overlapped with each other. As described below, the reservation control unit 26 optimizes the placement of the vehicles in the parking candidate site so that the parking spaces for the vehicles having similar vehicle specifications are overlapped with each other. Assume that, as shown in FIG. 6, in the parking candidate site, reservations have been made for vehicle A in which the allowed number of occupants is 5 and vehicle B in which the allowed number of occupants is 2. Then assume that new reservations are made for vehicle C in which the allowed number of occupants is 5 and vehicle D and vehicle E in each of which the allowed number of occupants is 2. In this case, the vehicles in which the allowed number of occupants is 5 are arranged so that an occupied area for vehicle A is overlapped with an approach area for vehicle C in which the allowed number of occupants is also 5. Similarly, the vehicles in which the allowed number of occupants is 2 are arranged so that an occupied area for vehicle B is overlapped with an approach area for vehicle D and an occupied area for vehicle D is overlapped with an approach area for vehicle E.

In the first case, the vehicles allocated at the time of reservation can be exchanged according to an arrival time of the users who have made the reservation using the user terminal 16.

In the center 12, when the communication unit 20 receives, from the user terminal 16, an arrival time at the boarding/alighting location, the reservation control unit 26 determines whether the exchange is possible, and if possible, the reservation control unit 26 exchanges the vehicles allocated at the time of reservation. The user information management unit 22 transmits, via the communication unit 20 to the user terminal 16 of each of the users who have reserved the exchanged vehicles, a notification notifying the users to board the vehicle allocated after the change. A case will be described below where vehicle allocations for the users are exchanged when the reservation control unit 26 optimizes the placement of the vehicles in the parking candidate site so that the parking spaces for the vehicles having similar vehicle specifications are overlapped with each other.

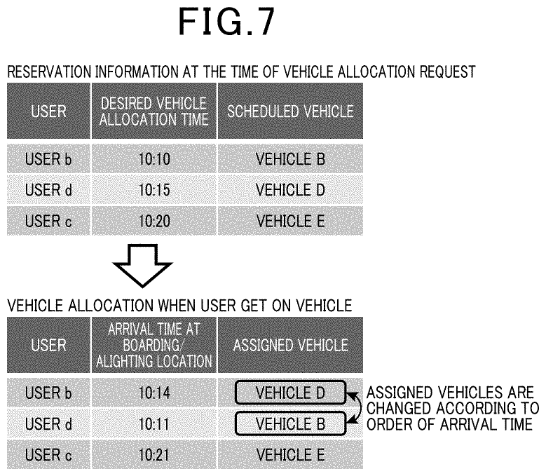

FIG. 7 shows a case where vehicle allocations for the users are exchanged between the vehicles having similar vehicle specifications. As shown in FIG. 7, according to the initial reservation information in the center 12, a desired vehicle allocation time of user b is 10:10, and a desired vehicle allocation time of user d is 10:15. Assume that vehicle B has been allocated to the reservation made by user b and vehicle D that follows vehicle B has been allocated to the reservation made by user d. Assume, however, that an arrival time of user b at the boarding/alighting location is delayed until 10:14, and an arrival time of user d at the boarding/alighting location is 10:11. In this case, according to the arrival time of the users at the boarding location, the reservation control unit 26 exchanges the vehicles assigned to the users so that vehicle B is exchanged with vehicle D. That is, vehicle D is assigned to user b, and vehicle B is assigned to user d. Since vehicle B and vehicle D have the similar vehicle specifications, vehicle B and vehicle D can mutually accept the number of occupants, and thus the exchange is possible. The exchange of the vehicles allows smooth departure of the vehicles according to the order of arrival time of the users and improves user convenience.

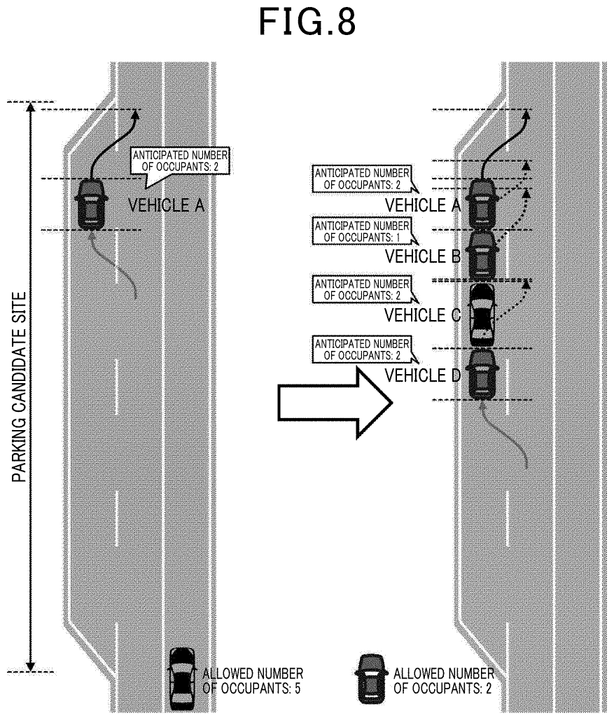

Next, as the second case, a case where the vehicles can mutually accept the number of occupants will be described. FIG. 8 shows an example in which the parking spaces for the vehicles that mutually accept the number of occupants are overlapped with each other. As described below, the reservation control unit 26 optimizes the placement of the vehicles in the parking candidate site so that the parking spaces for the vehicles that mutually accept the number of occupants are overlapped with each other. Assume that, as shown in FIG. 8, in the parking candidate site, a reservation has been made for vehicle A in which the anticipated number of occupants is 2. Then assume that new reservations are made for vehicle B in which the anticipated number of occupants is 1, vehicle C in which the anticipated number of occupants is 2, and vehicle D in which the anticipated number of occupants is 2. In this case, vehicles A to D can mutually accept the number of occupants. Thus, vehicles A to D are arranged so that an occupied area for vehicle A is overlapped with an approach area for vehicle B, an occupied area for vehicle B is overlapped with an approach area for vehicle C, and an occupied area for vehicle C is overlapped with an approach area for vehicle D.

Also in the second case, as in the first case, the vehicles allocated at the time of reservation can be exchanged according to an arrival time of the users who have made the reservation using the user terminal 16. A case will be described below where the reservation control unit 26 optimizes the placement of the vehicles in the parking candidate site so that the parking spaces for the vehicles that mutually accept the number of occupants are overlapped with each other.

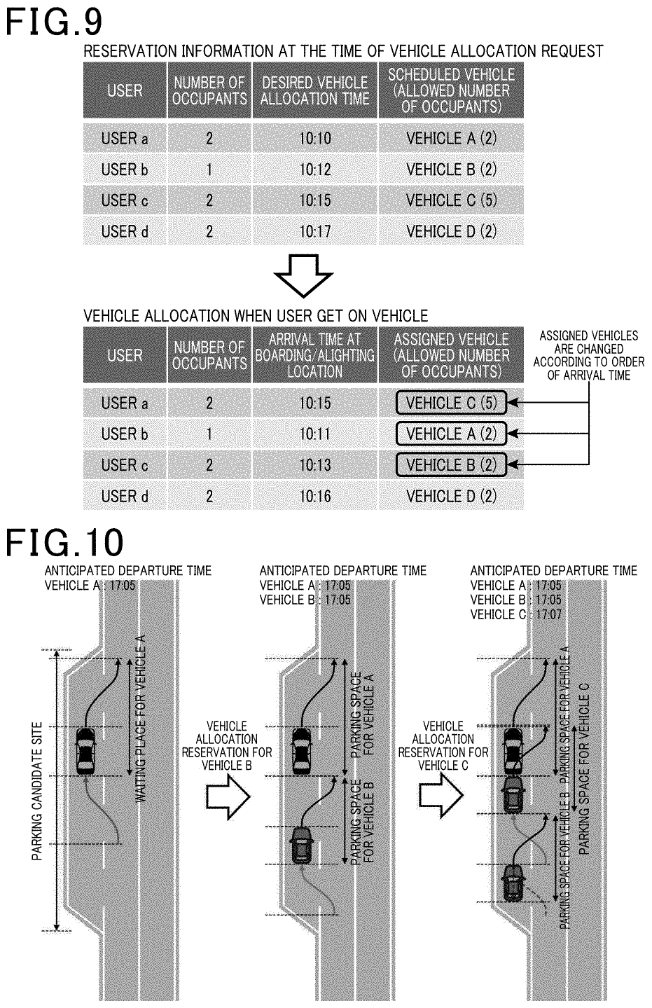

FIG. 9 shows a case where vehicle allocations for the users are exchanged between the vehicles that mutually accept the number of occupants. As shown in FIG. 9, according to the initial reservation information in the center 12, a desired vehicle allocation time of user a is 10:10, a desired vehicle allocation time of user b is 10:12, and a desired vehicle allocation time of user c is 10:15. Assume that vehicle A has been allocated to the reservation made by user a, vehicle B that follows vehicle A has been allocated to the reservation made by user b, and vehicle C has been allocated to the reservation made by user c. Assume, however, that an arrival time of user a at the boarding/alighting location is delayed until 10:15, an arrival time of user b at the boarding/alighting location is 10:11, and an arrival time of user c at the boarding/alighting location is 10:13. In this case, according to the arrival time of the users at the boarding location, the reservation control unit 26 exchanges the vehicles assigned to the users so that the vehicles are assigned in the order of vehicle C, vehicle A, and vehicle B. That is, vehicle C is assigned to user a, vehicle A is assigned to user b, and vehicle B is assigned to user c. Since vehicles A to C can mutually accept the number of occupants, vehicles A to C can be exchanged with each other. The exchange of the vehicles allows smooth departure of the vehicles according to the order of arrival time of the users and improves user convenience.

Next, as the third case, a case where the parking spaces for the vehicles are overlapped with each other based on anticipated departure time will be described. FIG. 10 shows an example in which the parking spaces for the vehicles are overlapped with each other based on departure time. As described below, the reservation control unit 26 optimizes the placement of the vehicles in the parking candidate site so that the parking spaces for the vehicles are overlapped with each other based on departure time. Assume that, as shown in FIG. 10, in the parking candidate site, a reservation for vehicle A is made and an anticipated departure time of vehicle A is 17:05. The anticipated departure time may be set, for example, to a predetermined appropriate time such as a few minutes after an anticipated boarding time. Next, assume that a reservation for vehicle B is made and an anticipated departure time of vehicle B is 17:05. At this time, the parking spaces for vehicle A and vehicle B are fit in the parking candidate site. Thus, at the time of the reservation, the reservation control unit 26 arranges the vehicles so that the parking spaces for the vehicles are not overlapped with each other. Next, assume that a reservation for vehicle C is made and an anticipated departure time of vehicle C is 17:07. In this case, the parking space for the vehicles are not fit in the parking candidate site unless the parking spaces for the vehicles are overlapped with each other. Thus, the reservation control unit 26 arranges the vehicles so that the parking spaces for the vehicles are overlapped with each other based on departure time. For example, the reservation control unit 26 arranges the vehicles so that the parking spaces for the vehicles with non-overlapping anticipated departure times are overlapped with each other. For example, since the anticipated departure time of vehicle A is earlier than the anticipated departure time of vehicle C, the reservation control unit 26 arranges the vehicles so that an occupied area for vehicle A is overlapped with an approach area for vehicle C.

The cases where the parking spaces can be overlapped with each other have been described. When applying one of the three cases, the reservation control unit 26 may determine priorities for the cases and apply a case with higher priority. The reservation control unit 26 may apply two or more of the cases at the same time.

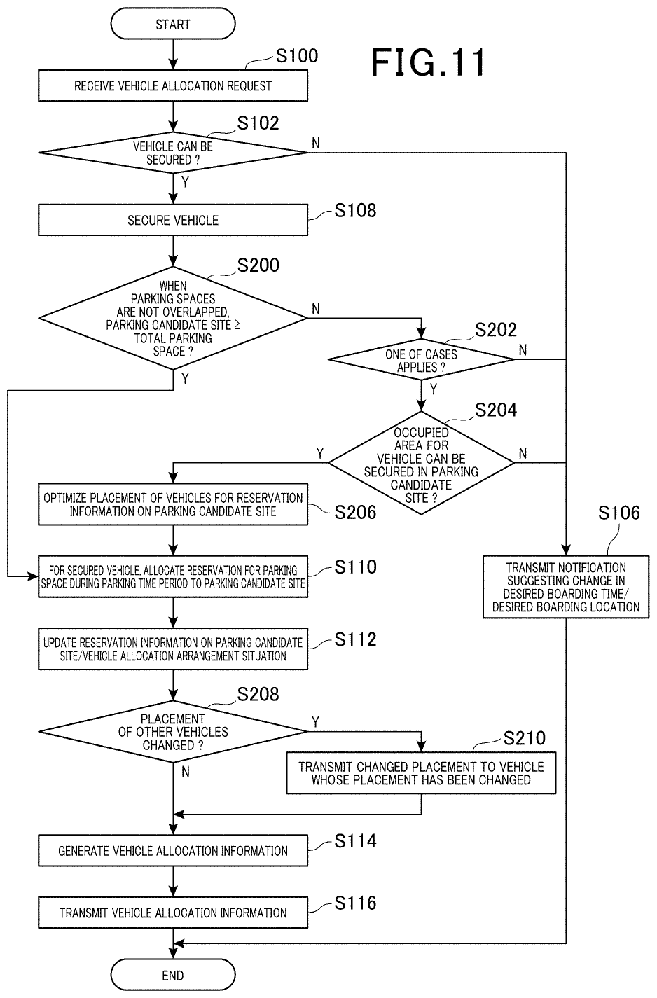

Next, an operation of the management system 10 according to the second embodiment of the present disclosure will be described. FIG. 11 is a flow chart showing a processing routine at the time of reservation performed by the management system 10 according to the second embodiment of the present disclosure. The same process steps are given the same reference numerals and will not be described.

After the vehicle is secured at step S108, control proceeds to step S200.

At step S200, based on the reservation information on the parking candidate site, the reservation control unit 26 determines whether when the parking spaces are not overlapped with each other, the condition that the size of the parking candidate site the total size of the necessary parking space is satisfied. If the condition is satisfied, control proceeds to step S110, and if not, control proceeds to step S202.

At step S202, the reservation control unit 26 determines whether one of the three cases applies, and if one of the three cases applies, control proceeds to step S204, and if not, control proceeds to step S106.

At step S204, the reservation control unit 26 determines whether when the parking spaces are overlapped with each other, an occupied area for the vehicle can be secured in the parking candidate site, and if an occupied area for the vehicle can be secured, control proceeds to step S206, and if not, control proceeds to step S106.

At step S206, according to the case determined at step S202, for the reservation information on the parking candidate site in the reservation management DB 32, the reservation control unit 26 optimizes the placement of the vehicles so that the parking spaces for the vehicles are overlapped with each other according to the corresponding case. After step S206, through steps S110 and S112, control proceeds to step S208.

At step S208, the reservation control unit 26 determines whether the placement of other vehicles 14 has been changed, and if the placement has been changed, control proceeds to step S210, and if not, control proceeds to step S114.

At step S210, the reservation control unit 26 transmits the changed placement from the communication unit 20 to the vehicles 14 whose placement has been changed, and control proceeds to step S114.

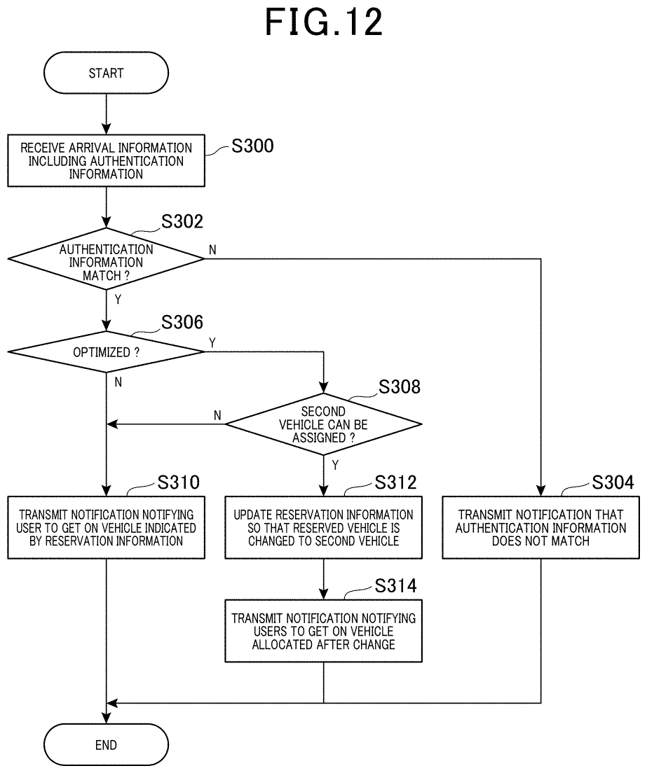

Next, a process performed by the management system 10 according to the second embodiment when the user boards the vehicle will be described. FIG. 12 is a flow chart showing a processing routine performed by the management system 10 according to the second embodiment of the present disclosure when the user boards the vehicle.

At step S300, the communication unit 20 receives, from the user terminal 16, arrival information including authentication information. A date and time at which the arrival information is received is determined as an arrival time.

At step S302, the reservation control unit 26 determines whether the authentication information matches the reservation information. If the authentication information matches the reservation information, control proceeds to step S306, and if not, control proceeds to step S304.

At step S304, the user information management unit 22 transmits, from the communication unit 20 to the user terminal 16, a notification that the authentication information does not match the reservation information.

At step S306, according to the reservation information on the parking candidate site in the reservation management DB 32, the reservation control unit 26 determines whether optimization has been performed so that the parking spaces are overlapped with each other. If the optimization has been performed, control proceeds to step S308, and if not, control proceeds to step S310.

At step S308, the reservation control unit 26 determines whether a second vehicle that can depart more smoothly can be assigned to the user. If such a second vehicle is available, control proceeds to step S312, and if not, control proceeds to step S310.

At step S310, the reservation control unit 26 transmits, from the communication unit 20 to the user terminal 16, a notification notifying the user to board the vehicle indicated by the reservation information in the reservation management DB 32.

At step S312, the reservation control unit 26 updates the reservation information in the reservation management DB 32 so that the vehicle allocated to the reservation corresponding to the user who has arrived at the boarding/alighting location is changed to the second vehicle that can be more smoothly departed. Furthermore, the reservation control unit 26 updates the reservation information so that the vehicle initially scheduled to be allocated to the user who has arrived at the boarding/alighting location is allocated to a reservation corresponding to another user to whom the second vehicle has been scheduled to be allocated.

At step S314, based on the reservation information updated at step S312, the user information management unit 22 transmits, from the communication unit 20 to the corresponding user terminal 16, a notification notifying the users for whom the allocated vehicle has been changed to board the vehicle allocated after the change.

As described above, the management system 10 according to the second embodiment of the present disclosure can perform vehicle allocation by efficiently using the space and appropriately manage vehicle allocation. Furthermore, the unified management of vehicle allocation performed by the center 12 can mitigate the risk that the parking space in which the vehicle is allocated is unavailable.

The present disclosure is not limited to the above embodiments, and various modifications and applications are possible without departing from the scope of the present disclosure.

For example, when a plurality of parking spaces are available for reservation, the reservation control unit 26 may receive designation of a parking space from the user terminal 16 and allocate a reservation to the designated parking space.

As in the case of vehicle allocation for the boarding location, the center 12 may also manage a reservation in a parking candidate site for a alighting location. In this case, the communication unit 20 receives a desired alighting location from the user terminal 16. Based on the desired boarding time or the departure time, the reservation control unit 26 estimates an arrival time at the desired alighting location, and makes a reservation for a parking space during a time period corresponding to the anticipated arrival time in a parking candidate site corresponding to the desired alighting location. Also in the reservation for a alighting location, as in the case of vehicle allocation, when no parking space can be allocated, a notification suggesting a change may be transmitted. Furthermore, when a plurality of parking spaces are available for reservation, designation may be received from the user terminal 16.

The management system 10 may monitor the parking candidate site by using a sensor installed in the parking candidate site to determine whether the reserved parking space is available. When the sensor detects an external factor (e.g., a case where a vehicle not under management by the management system 10 or the like is parked in the parking space), the reservation control unit 26 determines whether the waiting place for the reserved vehicle is unavailable. When the reservation control unit 26 determines that the waiting place for the reserved vehicle is unavailable, the reservation control unit 26 makes a new reservation for an available parking space in a parking candidate site in the vicinity of the desired boarding location. The user information management unit 22 notifies the change in location of the parking space to the user terminal 16. The determination of whether the waiting place for the reserved vehicle is unavailable may be performed by notifying an administrator of detection information on the external factor to allow the administrator to make a determination.

The present specification has described the embodiments in which the program has been installed in advance, but the program may be stored in a computer readable recording medium.

What is claimed is:

1. A management system for managing vehicle parking, the management system comprising:
a communication unit configured to receive, from a user, a vehicle allocation request including a number of occupants, a desired boarding location, and a desired boarding time;
a vehicle selection unit configured to secure one or more vehicles corresponding to the number of occupants based on the vehicle allocation request; and
a reservation control unit configured to, in response to a parking space for the secured vehicle being able to be allocated to a parking candidate site corresponding to the desired boarding location during a parking time period corresponding to the desired boarding time, allocate a reservation for the parking space during the parking time period to the parking candidate site and allocate the vehicle to the user.

2. The management system according to claim 1, wherein:
the parking space includes an occupied area and one or more approach areas, the occupied area is a space occupied by a vehicle when parking of the vehicle is completed, and the approach area is a space required to be secured for departure of the vehicle; and
in response to, in the parking candidate site, the occupied area for each vehicle to be reserved and the one or more approach areas being allocatable during the parking time period, the reservation control unit allocates the reservation for the parking space for the secured vehicle to the parking candidate site.

3. The management system according to claim 2, wherein the occupied area and the approach area have a predetermined size according to a vehicle type of the secured vehicle.

4. The management system according to claim 2, wherein
in response to, in the parking candidate site, a plurality of the vehicle allocation requests having been made for overlapping parking time periods and a new reservation not being able to be allocated unless the parking spaces for vehicles are overlapped with each other, the reservation control unit optimizes placement of the vehicles in the parking candidate site according to a predetermined condition to cause an overlap in which the occupied area of the parking space allocated to a vehicle that is parked on a front side is overlapped with the approach area for a vehicle that follows the vehicle parked on the front side and is parked on a rear side.

5. The management system according to claim 4, wherein
the condition is such that the vehicles have similar vehicle specifications, and
the reservation control unit optimizes the placement of the vehicles in the parking candidate site so that the overlap is made between the vehicles having similar vehicle specifications.

6. The management system according to claim 4, wherein
the condition is such that the vehicles mutually accept the number of occupants indicated by the vehicle allocation requests, and
the reservation control unit optimizes the placement of the vehicles in the parking candidate site so that the overlap is made between the vehicles that mutually accept the number of occupants indicated by the vehicle allocation requests.

7. The management system according to claim 5, wherein in a case where a plurality of reservations have been made for overlapping parking time periods, in response to an arrival time of the user at the parking candidate site differing from the desired boarding time, the reservation control unit changes a first vehicle for the reservation made by the user to a second vehicle, and the second vehicle is a reserved vehicle different from the first vehicle, and corresponds to the arrival time and accepts the number of occupants.

8. The management system according to claim 6, wherein in a case where a plurality of reservations have been made for overlapping parking time periods, in response to an arrival time of the user at the parking candidate site differing from the desired boarding time, the reservation control unit changes a first vehicle for the reservation made by the user to a second vehicle, and the second vehicle is a reserved vehicle different from the first vehicle, and corresponds to the arrival time and accepts the number of occupants.

9. The management system according to claim 4, wherein
the condition is an order of predetermined departure time, and
the reservation control unit optimizes the placement of the vehicles in the parking candidate site so that the overlap is made in the order of departure time.

10. The management system according to claim 1, wherein the reservation control unit monitors the parking candidate site by using a sensor to determine whether the reserved parking space is available, and the sensor is installed in advance in the parking candidate site.

11. The management system according to claim 1, wherein, in response to, in the parking candidate site, a plurality of the parking spaces being available for the reservation, the reservation control unit receives designation of the parking space from the user.

12. The management system according to claim 1, wherein, in response to the parking space not being able to be allocated to the parking candidate site during the parking time period, the communication unit notifies the user to change the desired boarding location or the desired boarding time.

13. The management system according to claim 1, wherein:
the communication unit receives a desired alighting location from the user; and
based on the desired boarding time or a departure time, the reservation control unit estimates an arrival time at the desired alighting location, and allocates a reservation for the parking space during a time period corresponding to the anticipated arrival time to a parking candidate site corresponding to the desired alighting location.

14. A management method for managing vehicle parking, the management method comprising:
receiving, from a user, a vehicle allocation request including the number of occupants, a desired boarding location, and a desired boarding time;
securing one or more vehicles corresponding to the number of occupants based on the vehicle allocation request; and
in response to a parking space for the secured vehicle being allocated to a parking candidate site corresponding to the desired boarding location during a parking time period corresponding to the desired boarding time, allocating a reservation for the parking space during the parking time period to the parking candidate site and allocating the vehicle to the user.

15. A management system for managing vehicle parking, the management system comprising:
a non-transitory memory storing one or more computer programs;
a processor executing the one or more programs to:
receive, from a user, a vehicle allocation request including a number of occupants, a desired boarding location, and a desired boarding time;
secure one or more vehicles corresponding to the number of occupants based on the vehicle allocation request; and
in response to a parking space for the secured vehicle being allocated to a parking candidate site corresponding to the desired boarding location during a parking time period corresponding to the desired boarding time, allocate a reservation for the parking space during the parking time period to the parking candidate site and allocating the vehicle to the user.
